(19) United States
(12) Patent Application Publication
(10) Pub. No.: US 2023/0111874 A1
(43) Pub. Date: Apr. 13, 2023

(54) DEVICE EMULATIONS IN A NOTEBOOK SESSION

(71) Applicant: Oracle International Corporation, Redwood Shores, CA (US)

(72) Inventor: Hari Bhaskar Sankaranarayanan, Bengaluru (IN)

(73) Assignee: Oracle International Corporation, Redwood Shores, CA (US)

(21) Appl. No.: 17/499,743

(22) Filed: Oct. 12, 2021

(51) Int. Cl. G06F 9/50; G06F 9/455; G06N 20/00

(52) U.S. Cl. CPC G06F 9/5077; G06F 9/5055; G06F 9/45558; G06N 20/00; G06F 2009/45562

(57) ABSTRACT

A framework for deploying, within a notebook session, a machine-learning model to an emulation environment. Responsive to a first input entered in a notebook requesting an emulator for a device: receiving, by a computer system, a first request for the emulator for the device, and identifying a compute instance that is loaded with the emulator for the device. Responsive to a second input entered in the notebook identifying an application package to be loaded in the compute instance, loading, by the computer system, the application package in the compute instance, and executing the emulator for the device based on the application package.

### FIELD

The present disclosure relates to a framework for deploying, within a notebook session, a machine-learning model to an emulation environment.

### BACKGROUND

The rise and proliferation of artificial intelligence (AI) has led to many groundbreaking applications in different industries. The advancements in AI technology have allowed many of the backend profiling AI capabilities to be deployed on mobile devices itself. Typically, application developers, data scientists, machine-learning engineers etc., are required to perform emulation of mobile devices having different configuration parameters. Usually emulations are performed in a standalone manner. Specifically, lightweight machine-learning models are deployed and tested separately i.e., in an independent manner, thereby making it harder to have a consistent view of development to deployment across various forms of deployments. Embodiments discussed herein address these and other issues individually as well as collectively.

### SUMMARY

The present disclosure relates generally to a framework for deploying, within a notebook session, a machine-learning model to an emulation environment. Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the detailed description section, and further description is provided therein.

An aspect of the present disclosure provides for a method comprising: responsive to a first input entered in a notebook requesting an emulator for a device, receiving, by a computer system, a first request for the emulator for the device; and identifying, by the computer system, a compute instance that is loaded with the emulator for the device; and responsive to a second input entered in the notebook identifying an application package to be loaded in the compute instance, loading, by the computer system, the application package in the compute instance; and executing the emulator for the device based on the application package.

Another aspect of the present disclosure provides for a non-transitory computer-readable memory storing a plurality of instructions which when executed by one or more processors perform processing comprising: responsive to a first input entered in a notebook requesting an emulator for a device, receiving, by a computer system, a first request for the emulator for the device; and identifying a compute instance that is loaded with the emulator for the device; and responsive to a second input entered in the notebook identifying an application package to be loaded in the compute instance, loading the application package in the compute instance; and executing the emulator for the device based on the application package.

One aspect of the present disclosure provides for computer system comprising: a processor; and a memory storing executable instructions, which when executed by the processor, causes the computer system to perform operations including: responsive to a first input entered in a notebook requesting an emulator for a device, receive a first request for the emulator for the device; and identify a compute instance that is loaded with the emulator for the device; and responsive to a second input entered in the notebook identifying an application package to be loaded in the compute instance, load the application package in the compute instance; and execute the emulator for the device based on the application package.

The foregoing, together with other features and embodiments will become more apparent upon referring to the following specification, claims, and accompanying drawings.

### BRIEF DESCRIPTION OF THE DRAWINGS

FIG. 1 depicts an exemplary architecture of a distributed network environment in accordance with various embodiments.

FIG. 2 depicts an exemplary schematic illustrating interaction between different components of the distributed network environment in accordance with various embodiments.

FIG. 3 depicts another exemplary schematic illustrating interaction between different components of the distributed network environment in accordance with various embodiments.

FIG. 4A depicts an exemplary flow diagram illustrating a process performed by a computer system of the distributed network environment, in accordance with various embodiments.

FIG. 4B depicts an exemplary user interface (UI) illustrating a notebook and an instance of an emulator for a device, in accordance with various embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Artificial Intelligence (AI) is a backbone for many groundbreaking applications in different industries. In today's world, AI is taking center stage in mobile devices (e.g., smartphones), and it goes far beyond applications like digital assistants. The advancements in AI technology allows many of the backend profiling AI capabilities to be deployed on the mobile devices itself. For instance, AI based on user profile, contextual interactions, and location-based services have enabled developers to build machine-learning (ML) models that can be executed on mobile devices. Such mobile devices offer good compute power to run lightweight versions of the models for inference purposes.

Typically, application developers, data scientists, machine-learning engineers etc., are required to perform emulation of mobile devices having different configuration parameters e.g., operating system, device type, form factors, etc., to deduce inferences and analyze results. Usually each emulation is performed in a standalone manner. Specifically, the lightweight models are deployed and tested separately, which makes it harder to have a consistent view of development to deployment across various forms of deployments.

Further, Integrated Development Environments (IDEs) provide a framework to develop and analyze applications. However, IDEs tend to be large (in size) and most are designed with only one platform, or one platform vendor in mind (e.g. Visual Studio, xCode, etc.). For developers that target multiple platforms, using these IDEs means that the developers are required to download, install and manage multiple platform software development kits (SDKs) and two or more separate development environments. This is a time consuming process, which tends to lower user satisfaction.

The present disclosure describes new and improved techniques of performing device emulations. Specifically, aspects of the present disclosure provide for a framework to conduct emulations from within a notebook environment. A notebook is a web-based application that supports a wide range of workflows in data science, scientific computing, and machine learning. Specifically, the notebook (i.e., the web-based application) is a type of integrated development environment that can be used for training and lifecycle management of machine-learning models. Aspects of the present disclosure provide for an integrated SDK approach for both server-side and client-side development. The integrated experience for both server-side and device-side support within a notebook environment provisions data scientists, application developers, and ML engineers the ability to emulate and test ML model inferences along with the application development in a seamless manner. It is appreciated that once the emulation is completed and tested, the mobile application, model and overall deployment can be taken further for full downstream deployment and implementation.

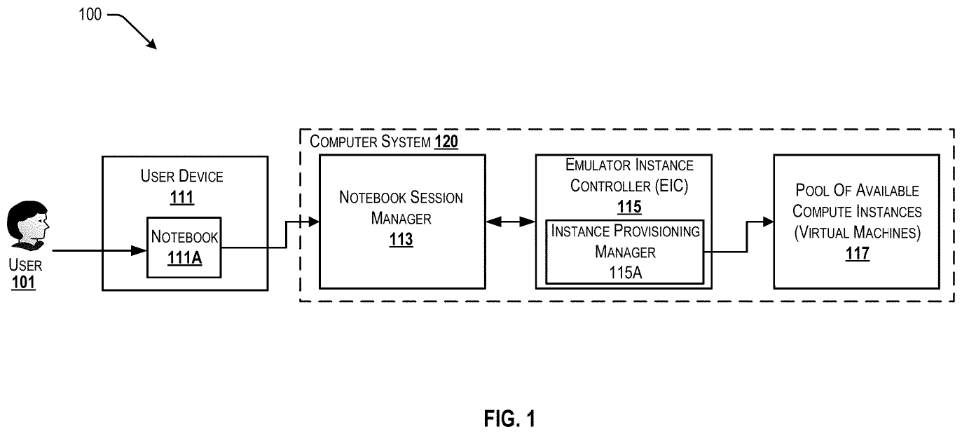

Turning to FIG. 1, there is depicted an exemplary architecture of a distributed network environment in accordance with various embodiments. The distributed network environment 100 includes a user 101 operating a user device 111, and a computer system 120. The computer system 120 includes a notebook session manager 113, an emulator instance controller (EIC) 115, and a pool of available compute instances 117. The pool of compute instances may correspond to a pool of available virtual machines for performing emulations.

The user device 111 may correspond to a mobile device. The mobile device may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, wearable devices (e.g., watches), vehicles (e.g., cars), etc. A mobile device may comprise any suitable hardware and software for performing such functions, and may also include multiple devices or components (e.g., when a device has remote access to a network by tethering to another device—i.e., using the other device as a relay—both devices taken together may be considered a single mobile device).

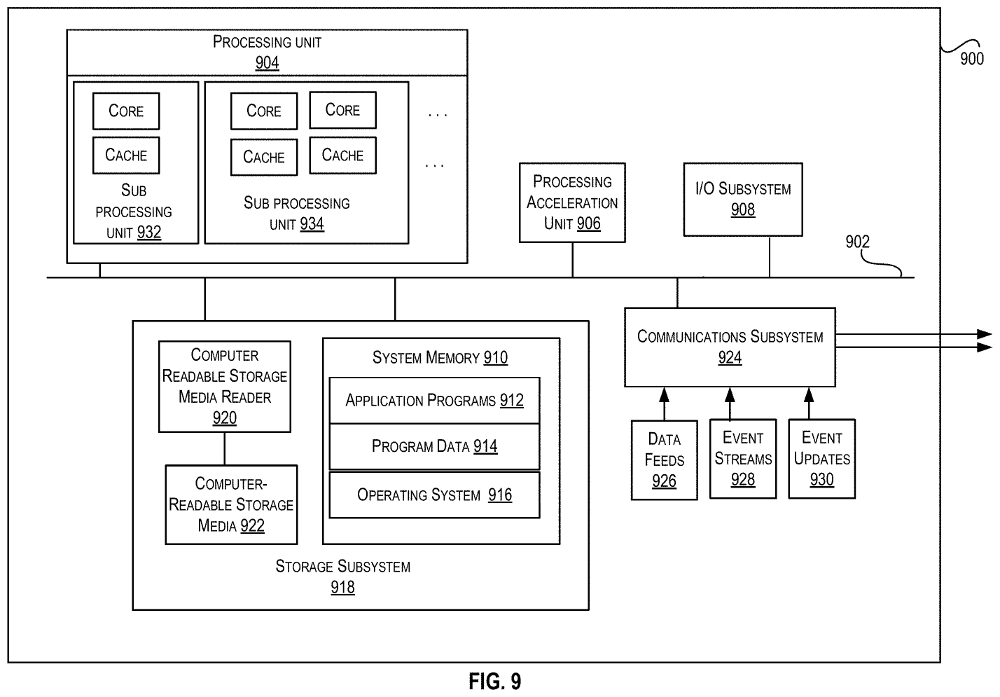

By some embodiments, the user device includes a notebook application 111A installed thereon. The notebook application (or referred to herein as a notebook) is a web-based application that supports a wide range of workflows in data science, scientific computing, and machine learning. Specifically, the notebook (i.e., the web-based application) is a type of integrated development environment that can be used for training and lifecycle management of machine-learning models. By some embodiments, the notebook 111A can be accessed by the user 101 via a web-browser installed on the user device 111. Essentially, the notebook 111A provides the user 101 an interface via which the user can issue commands (in some software programming language) and communicate with the notebook session manager 113 included in the computer system 120. It is appreciated that although FIG. 1 depicts a single computer system 120 to include both, the notebook session manager 113 as well as the EIC, this is in no way limiting the scope of the present disclosure. Rather, the notebook session manager 113 and the EIC 115 may be implemented on one or more computing systems, where each computing system is implemented by one or more computing devices. An example of a computing device is describe later with reference to FIG. 9.

The notebook session manager 113 controls and monitors a user session (i.e., a notebook session) created between the user device 111 and the computer system 120. It is noted that the creation of a notebook session enables the user 101 to write and exe cute code (e.g. Python code) using libraries in order to build and train machine-learning models.

By some embodiments, the EIC 115 includes an instance provisioning manager 115A that is programmed to pre-provision (i.e., preload) each compute instance with an operating system and an emulator. The instance provisioning manager 115A monitors the pool of available compute instances 117, and handles incoming user requests (i.e., requests for a specific emulator). Specifically, for each incoming user request, the instance provisioning manager 115A selects one compute instance from the pool of compute instances 117 that is to be assigned to the user. By some embodiments, the selection of the one compute instance may be performed based on information related to a manufacturer, a device type, a form factor of the device, a memory size of the device, etc., that may be included in the request issued by the user.

It is appreciated that the instance provisioning manager 115A may also be configured to adjust deployments of the compute instances in a dynamic manner based on a usage pattern of the compute instances over a pre-determined amount of time. For example, if in a span of a week, it is observed that a particular first type of emulator (e.g., emulator for IPhone (iOS)) is requested more than another type of emulator, then the instance provisioning manager 115A may ensure that a sufficient number of the first type of emulators are available in the pool of compute instances 117, in order to satisfy user requests in a timely manner. Furthermore, it is appreciated that rather than having the compute instances preloaded with the OS and the emulator, the instance provisioning manager 115A, may also be programmed to receive a user request (requesting a particular type of emulator), and provision a compute instance to include the requested emulator, on the fly i.e., provision the compute instances in a dynamic manner.

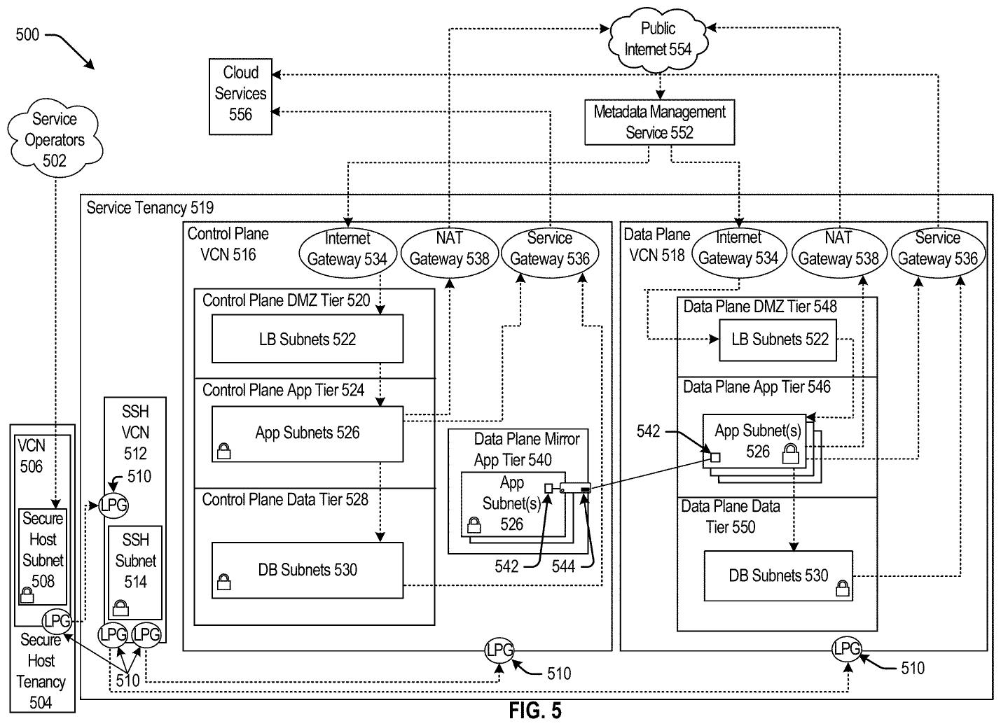

By some embodiments, the distributed network environment 100 of FIG. 1 may be implemented in a cloud infrastructure environment. In the cloud infrastructure environment, the notebook session manager 113 and the emulator instance controller 115 can be implemented in a control plane of the cloud environment, whereas the pool of available compute instances 117 can be implemented in a data plane of the cloud environment. Exemplary cloud infrastructure environments are described later with reference to FIGS. 5-9. In what follows, there is provided a detailed description illustrating interactions between different components of the distributed network environment 100 in accordance with various embodiments.

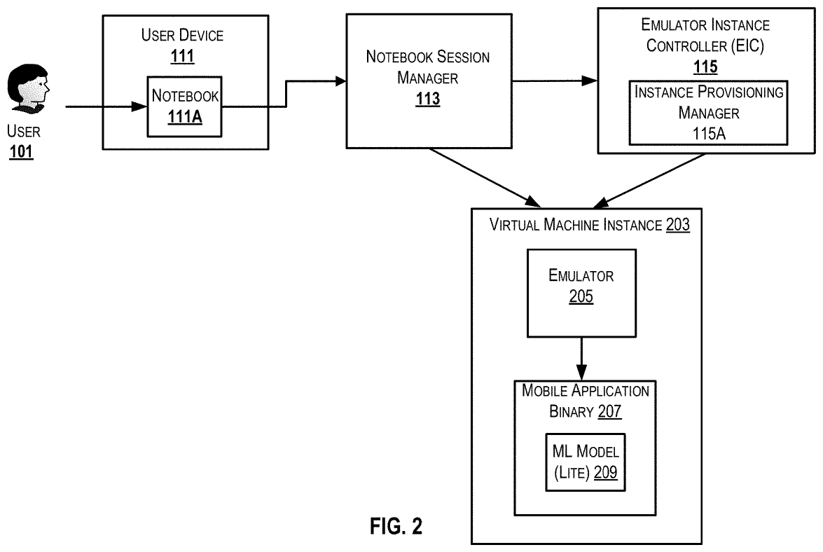

FIG. 2 depicts an exemplary schematic illustrating interaction between different components of the distributed network environment in accordance with various embodiments. The user 101 accesses the notebook 111A (i.e., the web application) via a browser installed on the user device 111. Upon accessing the notebook 111A, the user issues a command (e.g., in a command line) to setup a notebook session. The request to set up the notebook session is transmitted to the notebook session manager 113. Upon the creation of a notebook session, the user 101 issues a first input (in the notebook session) for an emulator for a device. By some embodiments, the first input identifies a manufacturer, and a device type characterizing the device the user wishes to emulate. Upon the user 101 inputting the first input, a request for the emulator required by the user is transmitted to the notebook session manager 113.

The notebook session manager 113, forwards the request to the emulator instance controller (EIC) 115. By some embodiments, the request forwarded by the notebook session manager is received by the instance provisioning manager 115A included in the EIC 115. The instance provisioning manager 115A extracts, from the request, information identifying a manufacturer and a device type (i.e., information identifying a type of emulator requested by the user). Upon extracting the information, the instance provisioning manager 115A queries the pool of compute instances to obtain a compute instance, which has been previously loaded by with an emulator that matches the type of emulator requested by the user. For example, as shown in FIG. 2, the instance provisioning manager 115A identifies a compute instance (i.e., a virtual machine) 203, that is preloaded with emulator 205, that is to be assigned to the user. It is noted that if a compute instance is not identified by the instance provisioning manager 115A, which is preloaded with the type of emulator requested by the user, the instance provisioning manager 115A may create (on the fly) a compute instance preloaded with the type of emulator requested by the user. By some embodiments, the notebook session manager 113 may receive a message (from the EIC 115) indicating a successful identification of the compute instance.

The notebook session manager 113 may notify the user (e.g., provide a visual display in the web browser) regarding a successful identification of a compute instance. Upon receiving the notification, the user 101 can issue another input (i.e., a second input) in the command line included in the web browser. The second input can identify (i) a mobile application, and (ii) a machine-learning model (both packaged as an application package) that the user wishes to load in the assigned compute instance. Upon the user entering the second input, a corresponding request including the application package the user wishes to execute is transmitted to the notebook session manager 113. Upon receiving the request, the notebook session manager 113 loads the application package i.e., the mobile application and the machine-learning model in the compute instance assigned to the user. For example, as shown in FIG. 2, the notebook session manager 113 loads a mobile application binary 207 and a machine-learning model (i.e., a lite ML model) within the instance of the virtual machine 203.

Upon the application package being loaded within the virtual machine instance, the user 101 issues another input e.g., a third input in the command line to perform testing of the emulator. In response to the third input being entered in the command line by the user, a request is transmitted to the notebook session manager 113, requesting the notebook session manager to commence execution of the emulator 205. Upon receiving such a request, the notebook session manager 113, executes the emulator based on the application package loaded in the virtual machine. It is appreciated that the machine-learning model 209 loaded in the virtual machine instance 203 is a lightweight machine-learning model (referred to herein as ML model lite). The lightweight ML model upon testing (via the emulator) is deployed on a user device (e.g., mobile device). As mobile devices have limited computing and memory resources, the mobile devices can load the lightweight ML model, which can provide the user on-device learning capabilities and inferences. Several use cases where such lightweight models may be used are described later.

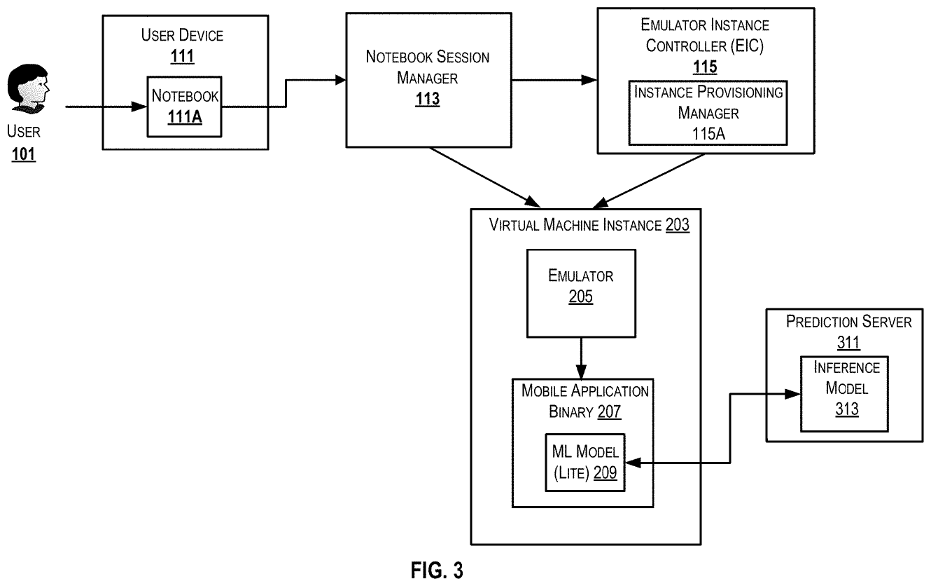

Turning now to FIG. 3, there is depicted another exemplary schematic illustrating interaction between different components of the distributed network environment in accordance with various embodiments. The interaction between the user device 111, the notebook session manager 113, the emulator instance controller 115, and the virtual machine instance 203 is similar to that as described above with reference to FIG. 2.

However, as shown in FIG. 3, according to some embodiments, an inference model 313 is deployed in a prediction server 311. The inference model 313 corresponds to a fully trained model i.e., a full ML model version of the ML lite model loaded in the virtual machine instance. As stated previously, the lightweight ML model (deployed in the virtual machine instance) can provide on-device inference capabilities i.e., the lightweight ML model can be executed independently of the inference model 313. However, there may be scenarios where the confidence in prediction(s) (e.g., for some data points) made by the lightweight model is lower than some threshold. In such cases, as shown in FIG. 3, the ML lite model 209 can communicate with the inference model 313 to obtain more accurate predictions for such data points. In this manner, the inference model 313 enables further training (i.e., in testing mode and/or in run-time mode) of the lightweight model deployed in the virtual machine instance.

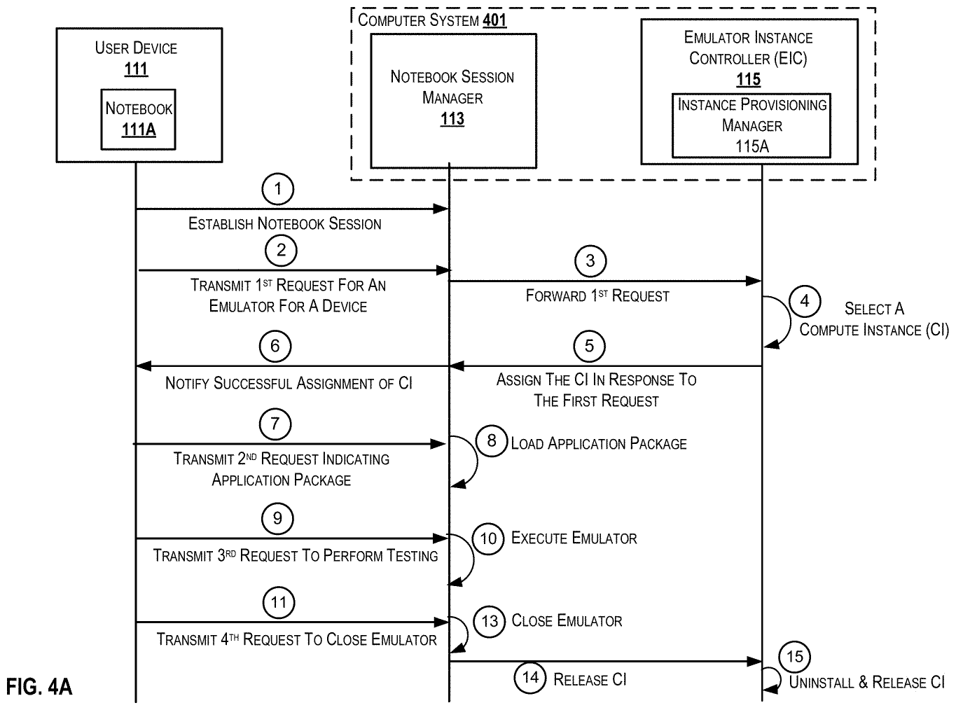

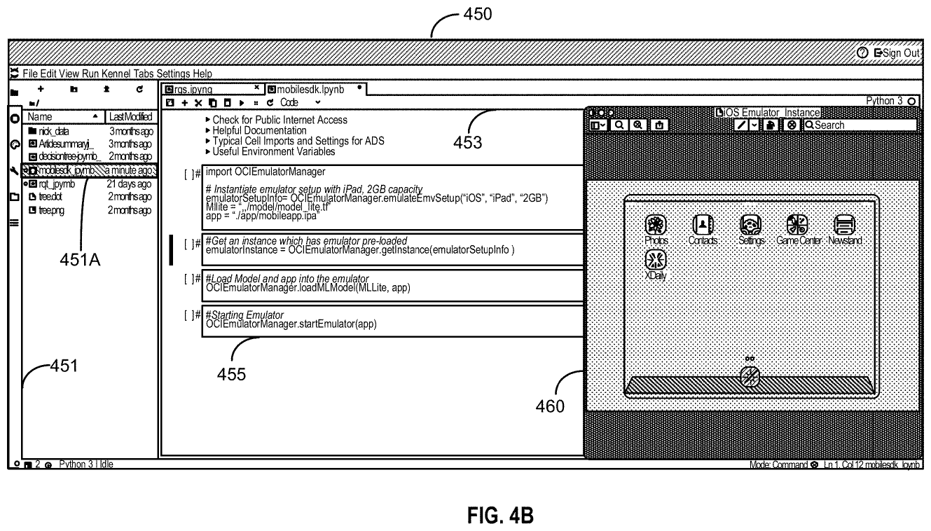

FIG. 4A depicts an exemplary flow diagram illustrating a process performed by a computer system of the distributed network environment, in accordance with various embodiments. The processing depicted in FIG. 4A may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4A and described below is intended to be illustrative and non-limiting. Although FIG. 4A depicts the various processing steps occurring in a particular sequence or order, this is not intended to be limiting. In certain alternative embodiments, the steps may be performed in some different order or some steps may also be performed in parallel.

In step 1, a user of the user device 111 accesses the notebook 111A (i.e., the web application) via a browser installed on the user device 111 and issues a command (e.g., in a command line included in the web browser) to setup a notebook session. The request to set up the notebook session is transmitted to the notebook session manager 113 included in the computer system 401. Upon the creation of a notebook session, in step 2, the user 101 issues a first input (in the notebook session) requesting an emulator for a device. By some embodiments, the first input identifies a manufacturer, and a device type characterizing the device the user wishes to emulate. Upon the user 101 inputting the first input, a request (i.e., a first request) for the emulator required by the user is transmitted to the notebook session manager 113. In step 3, the notebook session manager 113, forwards the request to the emulator instance controller (EIC) 115 included in the computer system 401. By some embodiments, the request forwarded by the notebook session manager is received by the instance provisioning manager 115A included in the EIC 115.

In step 4, the instance provisioning manager 115A extracts, from the request, information identifying a manufacturer and a device type (i.e., information identifying a type of emulator requested by the user). Upon extracting the information, the instance provisioning manager 115A queries a pool of compute instances to select a compute instance, which has been previously loaded with an emulator that matches the type of emulator requested by the user. It is noted that if a compute instance is not identified by the instance provisioning manager 115A, which is preloaded with the type of emulator requested by the user, the instance provisioning manager 115A may create (on the fly) a compute instance preloaded with the type of emulator requested by the user.

In step 5, the emulator instance controller 115 notifies the notebook session manager 113, that a compute instance has been assigned to the user in response to the first request. In step 6, the notebook session manager 113 transmits a message to the user device indicating a successful assignment of the compute instance.

In step 7, the user issues another input (i.e., a second input) in the command line included in the web browser. The second input can identify (i) a mobile application, and (ii) a machine-learning model (both packaged as an application package) that the user wishes to load in the assigned compute instance. Upon the user entering the second input, a corresponding request (i.e., a second request) including the application package the user wishes to execute is transmitted to the notebook session manager 113. In step 8, upon receiving the request, the notebook session manager 113 loads the application package i.e., the mobile application and the machine-learning model in the compute instance assigned to the user.

In step 9, the user issues another input e.g., a third input in the command line to perform testing of the emulator. In response to the third input being entered in the command line by the user, a request (e.g., a third request) is transmitted to the notebook session manager 113, requesting the notebook session manager to commence execution of the emulator. Upon receiving such a request, the notebook session manager 113, executes the emulator based on the application package loaded in the virtual machine in step 10. It is appreciated that the emulator being executed in the compute instance may provide the user de-bugging tools e.g., the user of the user device 111 may be presented with a visualization tool e.g., a pop-up window displayed on the user device 111 to analyze the emulation.

Upon completion of the emulation, in step 11, the user issues another request (i.e., a fourth request) to the notebook session manager 113 to close the emulator. In response, in step 13 the notebook session manager closes the emulator and releases the compute instance back to the emulator instance controller (step 14). Further, in step 15, the emulator instance controller 115 uninstalls (i.e., removes) the emulator from the compute instance (i.e., the virtual machine), and reassigns the compute instance back to a pool of compute instances. It is appreciated that in the above described embodiments, in terms of processes and memory, the emulator is executed inside the virtual machine as a process by itself. Further, the file transfers pertaining to loading the machine-learning model, synchronizing with inference server, loading mobile binary applications, etc., can be performed via file transfer protocols.

Turning now to FIG. 4B, there is depicted an exemplary user interface (UI) illustrating a notebook and an instance of an emulator for a device, in accordance with various embodiments. The UI 50 provides the user a visualization tool to analyze the emulation. As shown in FIG. 4B, the UI 450 includes a side pane 451, a notebook pane 453, and a representation of an emulator 460.

The side pane 451 may display a name 451A of a notebook session created by the user as well as provide an indication of a time instance the notebook session was last updated. The notebook pane 453 provides the user, for instance, a command interface via which the user can issue commands e.g., command 455 to start an emulator. Upon issuing the command (e.g. common 455), the user may be presented with a visual display of the requested emulator for a device e.g., an emulator for an iPad as shown in the representation 460. Upon executing the emulator, the user can analyze functionalities of the emulator within the visual representation of the emulator 460 included in the UI 450.

Illustrative Use Cases: As stated previously, once the testing of the emulator as described by the above embodiments is performed in the notebook session, the lightweight machine-learning model may be deployed to a mobile device (e.g., cellphone) for conducting real-time inferences. By some embodiments, the list of use cases are domain specific where the mobile device has a certain degree of capability to run lightweight machine-learning models to provide instant inferences that saves time, and also enable deducing inferences in situations where an active internet connection is readily available e.g., field inspections conducted in remote or restricted areas. The use case can involve detection of patterns such as user access patterns, location and activity patterns on the device, which are valuable to prevent any adverse events such as fraud.

As a first example, a lightweight machine-learning model may be used for phishing and fraud prevention. In this case, a machine learning model that is trained for predicting fraudulent transactions may be deployed (as a mobile application) on the mobile device. The application may use key strokes and movement(s) on the screens such as clicking links, buttons, etc., to detect an anomaly. If an anomaly is detected, the user may be notified of any fraud. Specifically, the lightweight machine-learning model generates alerts to the user (rather than waiting for the main inference server to return response, which is time consuming). Additionally, the lightweight model may also be programmed to alert the user via alternate means e.g., via a text message or an email message to another device in the instance if the device (operated by the user) is lost or misused by potential fraudsters. Further, to avoid false positives, the lightweight model may also capture frequently used gestures and infer them locally (e.g., key strokes, pattern of access, time and location of login etc.). It is appreciated that the above described use case is not only applicable for fraud detection but may also be applicable for situations such as detecting phishing attacks, where the mobile application alerts the user with respect to phishing links that the users may click. As such, the lightweight model may intercept browser requests, and generate alerts for safe browsing.

As another example, a lightweight machine-learning model may be used in applications such as field inspections. Typically, in field inspections related to detection of defects e.g., defects in machinery, equipment's, large-scale development projects, images are captured by a mobile device, wherein an application can process (e.g., via image detection algorithms), whether the captured images include any defects. In such a scenario, a local i.e., lightweight machine-learning model is trained to predict the scanned image(s) to determine whether the image includes any defects during field inspection. Such a scenario of utilizing the lightweight machine-learning model is even more pertinent, when the inspection is conducted in a remote place where internet access is not readily available. In such cases, the lightweight model can provide the user clues, by utilizing the image detection algorithm(s), which are pre-trained and loaded on the mobile device without relying on an inference model installed on an inference server (e.g., a backend server). As such, the usage of lightweight machine-learning model aids in rapid triaging on field to make further decisions.

### Example Infrastructure as Service Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more security group rules provisioned to define how the security of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep security breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Memory that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of security, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

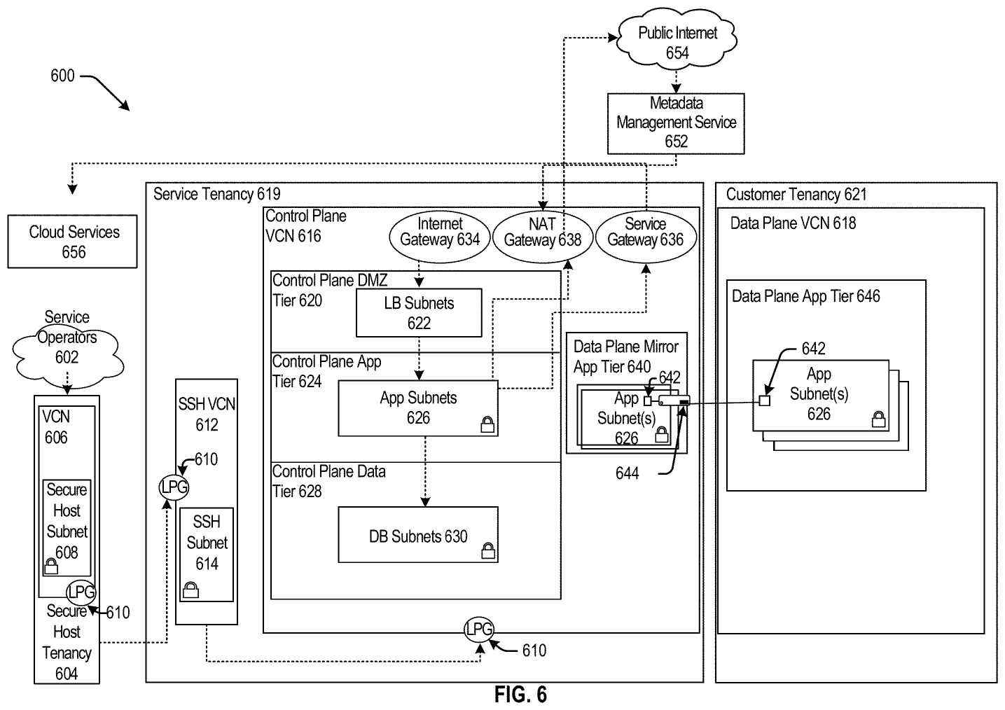

FIG. 6 is a block diagram 600 illustrating another example pattern of an IaaS architecture, according to at least one embodiment. Service operators 602 (e.g. service operators 502 of FIG. 5) can be communicatively coupled to a secure host tenancy 604 (e.g. the secure host tenancy 504 of FIG. 5) that can include a virtual cloud network (VCN) 606 (e.g. the VCN 506 of FIG. 5) and a secure host subnet 608 (e.g. the secure host subnet 508 of FIG. 5). The VCN 606 can include a local peering gateway (LPG) 610 (e.g. the LPG 510 of FIG. 5) that can be communicatively coupled to a secure shell (SSH) VCN 612 (e.g. the SSH VCN 512 of FIG. 5) via an LPG 510 contained in the SSH VCN 612. The SSH VCN 612 can include an SSH subnet 614 (e.g. the SSH subnet 514 of FIG. 5), and the SSH VCN 612 can be communicatively coupled to a control plane VCN 616 (e.g. the control plane VCN 516 of FIG. 5) via an LPG 610 contained in the control plane VCN 616. The control plane VCN 616 can be contained in a service tenancy 619 (e.g. the service tenancy 519 of FIG. 5), and the data plane VCN 618 (e.g. the data plane VCN 518 of FIG. 5) can be contained in a customer tenancy 621 that may be owned or operated by users, or customers, of the system.

The control plane VCN 616 can include a control plane DMZ tier 620 (e.g. the control plane DMZ tier 520 of FIG. 5) that can include LB subnet(s) 622 (e.g. LB subnet(s) 522 of FIG. 5), a control plane app tier 624 (e.g. the control plane app tier 524 of FIG. 5) that can include app subnet(s) 626 (e.g. app subnet(s) 526 of FIG. 5), a control plane data tier 628 (e.g. the control plane data tier 528 of FIG. 5) that can include database (DB) subnet(s) 630 (e.g. similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g. the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g. the service gateway of FIG. 5) and a network address translation (NAT) gateway 638 (e.g. the NAT gateway 538 of FIG. 5). The control plane VCN 616 can include the service gateway 636 and the NAT gateway 638.

The control plane VCN 616 can include a data plane mirror app tier 640 (e.g. the data plane mirror app tier 540 of FIG. 5) that can include app subnet(s) 626. The app subnet(s) 626 contained in the data plane mirror app tier 640 can include a virtual network interface controller (VNIC) 642 (e.g. the VNIC of 542) that can execute a compute instance 644 (e.g. similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g. the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g. the metadata management service 552 of FIG. 5) that can be communicatively coupled to public Internet 654 (e.g. public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g. cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 6,” may be located in Region 1 and in “Region 2.” If a call to Deployment 6 is made by the service gateway 636 contained in the control plane VCN 616 located in Region 1, the call may be transmitted to Deployment 6 in Region 1. In this example, the control plane VCN 616, or Deployment 6 in Region 1, may not be communicatively coupled to, or otherwise in communication with, Deployment 6 in Region 2.

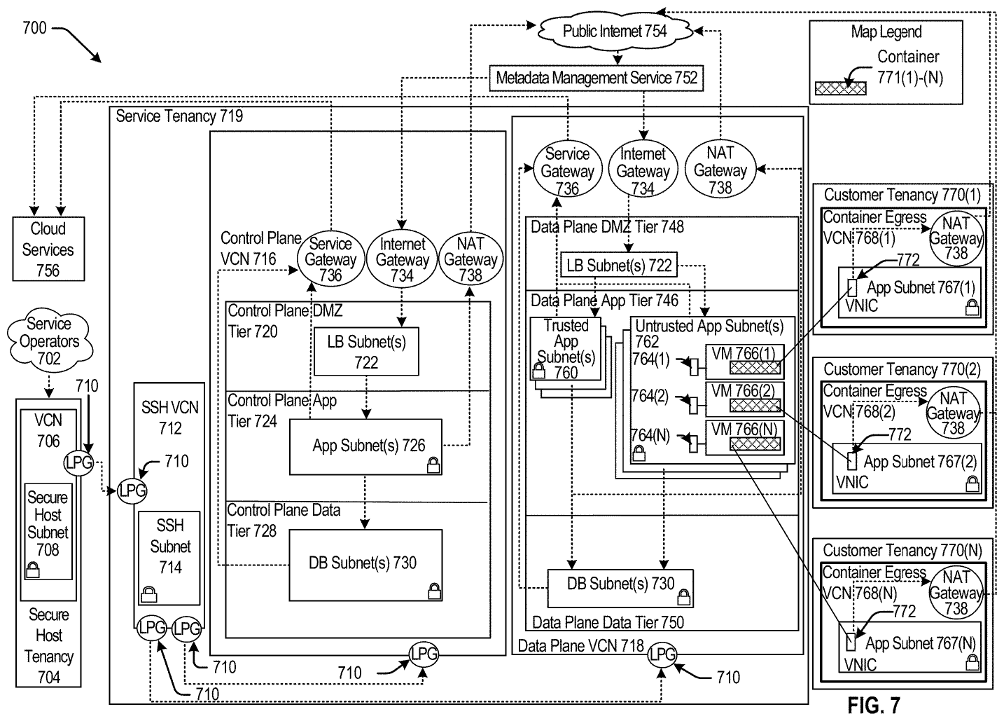

FIG. 7 is a block diagram 700 illustrating another example pattern of an IaaS architecture, according to at least one embodiment. Service operators 702 (e.g. service operators 502 of FIG. 5) can be communicatively coupled to a secure host tenancy 704 (e.g. the secure host tenancy 504 of FIG. 5) that can include a virtual cloud network (VCN) 706 (e.g. the VCN 506 of FIG. 5) and a secure host subnet 708 (e.g. the secure host subnet 508 of FIG. 5). The VCN 706 can include an LPG 710 (e.g. the LPG 510 of FIG. 5) that can be communicatively coupled to an SSH VCN 712 (e.g. the SSH VCN 512 of FIG. 5) via an LPG 710 contained in the SSH VCN 712. The SSH VCN 712 can include an SSH subnet 714 (e.g. the SSH subnet 514 of FIG. 5), and the SSH VCN 712 can be communicatively coupled to a control plane VCN 716 (e.g. the control plane VCN 516 of FIG. 5) via an LPG 710 contained in the control plane VCN 716 and to a data plane VCN 718 (e.g. the data plane 518 of FIG. 5) via an LPG 710 contained in the data plane VCN 718. The control plane VCN 716 and the data plane VCN 718 can be contained in a service tenancy 719 (e.g. the service tenancy 519 of FIG. 5).

The control plane VCN 716 can include a control plane DMZ tier 720 (e.g. the control plane DMZ tier 520 of FIG. 5) that can include load balancer (LB) subnet(s) 722 (e.g. LB subnet(s) 522 of FIG. 5), a control plane app tier 724 (e.g. the control plane app tier 524 of FIG. 5) that can include app subnet(s) 726 (e.g. similar to app subnet(s) 526 of FIG. 5), a control plane data tier 728 (e.g. the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g. the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g. the service gateway of FIG. 5) and a network address translation (NAT) gateway 738 (e.g. the NAT gateway 538 of FIG. 5). The control plane VCN 716 can include the service gateway 736 and the NAT gateway 738.

The data plane VCN 718 can include a data plane app tier 746 (e.g. the data plane app tier 546 of FIG. 5), a data plane DMZ tier 748 (e.g. the data plane DMZ tier 548 of FIG. 5), and a data plane data tier 750 (e.g. the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g. public Internet 554 of FIG. 5).

The Internet gateway 734 contained in the control plane VCN 716 and contained in the data plane VCN 718 can be communicatively coupled to a metadata management service 752 (e.g. the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

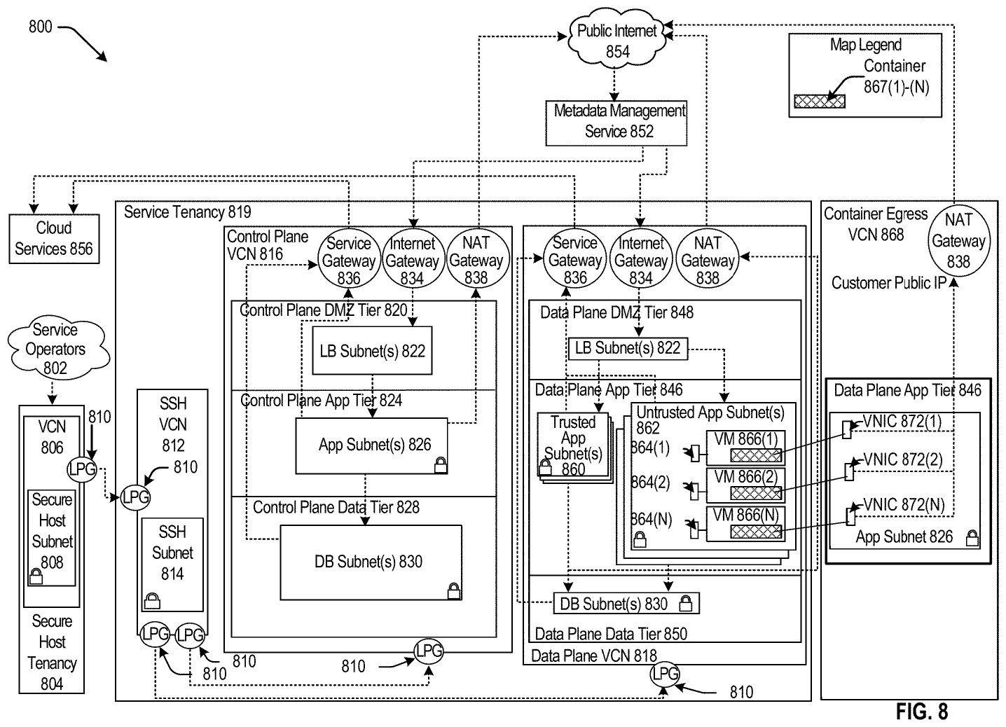

FIG. 8 is a block diagram 800 illustrating another example pattern of an IaaS architecture, according to at least one embodiment. Service operators 802 (e.g. service operators 502 of FIG. 5) can be communicatively coupled to a secure host tenancy 804 (e.g. the secure host tenancy 504 of FIG. 5) that can include a virtual cloud network (VCN) 806 (e.g. the VCN 506 of FIG. 5) and a secure host subnet 808 (e.g. the secure host subnet 508 of FIG. 5). The VCN 806 can include an LPG 810 (e.g. the LPG 510 of FIG. 5) that can be communicatively coupled to an SSH VCN 812 (e.g. the SSH VCN 512 of FIG. 5) via an LPG 810 contained in the SSH VCN 812. The SSH VCN 812 can include an SSH subnet 814 (e.g. the SSH subnet 514 of FIG. 5), and the SSH VCN 812 can be communicatively coupled to a control plane VCN 816 (e.g. the control plane VCN 516 of FIG. 5) via an LPG 810 contained in the control plane VCN 816 and to a data plane VCN 818 (e.g. the data plane 518 of FIG. 5) via an LPG 810 contained in the data plane VCN 818. The control plane VCN 816 and the data plane VCN 818 can be contained in a service tenancy 819 (e.g. the service tenancy 519 of FIG. 5).

The control plane VCN 816 can include a control plane DMZ tier 820 (e.g. the control plane DMZ tier 520 of FIG. 5) that can include LB subnet(s) 822 (e.g. LB subnet(s) 522 of FIG. 5), a control plane app tier 824 (e.g. the control plane app tier 524 of FIG. 5) that can include app subnet(s) 826 (e.g. app subnet(s) 526 of FIG. 5), a control plane data tier 828 (e.g. the control plane data tier 528 of FIG. 5) that can include DB subnet(s) 830 (e.g. DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g. the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g. the service gateway of FIG. 5) and a network address translation (NAT) gateway 838 (e.g. the NAT gateway 538 of FIG. 5). The control plane VCN 816 can include the service gateway 836 and the NAT gateway 838.

The data plane VCN 818 can include a data plane app tier 846 (e.g. the data plane app tier 546 of FIG. 5), a data plane DMZ tier 848 (e.g. the data plane DMZ tier 548 of FIG. 5), and a data plane data tier 850 (e.g. the data plane data tier 550 of FIG. 5). The data plane DMZ tier 848 can include LB subnet(s) 822 that can be communicatively coupled to trusted app subnet(s) 860 (e.g. trusted app subnet(s) 760 of FIG. 7) and untrusted app subnet(s) 862 (e.g. untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g. public Internet 554 of FIG. 5).

The Internet gateway 834 contained in the control plane VCN 816 and contained in the data plane VCN 818 can be communicatively coupled to a metadata management service 852 (e.g. the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
responsive to a first input entered in a notebook requesting an emulator for a device,
receiving, by a computer system, a first request for the emulator for the device; and
identifying, by the computer system, a compute instance that is loaded with the emulator for the device; and
responsive to a second input entered in the notebook identifying an application package to be loaded in the compute instance,
loading, by the computer system, the application package in the compute instance; and
executing the emulator for the device based on the application package.

2. The method of claim 1, wherein the application package includes a machine-learning model and a mobile application.

3. The method of claim 1, wherein the first input identifies a manufacturer, and a device type characterizing the device.

4. The method of claim 3, wherein the device type is further characterized by an operating system of the device, a form factor of the device, and a memory size of the device

5. The method of claim 1, where in the compute instance is a virtual machine.

6. The method of claim 1, wherein the computer system includes a notebook session manager and an emulator instance controller, and wherein the receiving, the loading, and the executing are performed by the notebook session manager, and the identifying is performed by the emulator instance controller.

7. The method of claim 6, further comprising:
provisioning, by the emulator instance controller, a plurality of compute instances, each of which is preloaded with an operating system and a particular emulator for a particular device.

8. The method of claim 1, further comprising:
responsive to a third input entered in the notebook indicating a termination of the emulator for the device,
receiving, by the computer system, a third request indicating the third input;
uninstalling the emulator for the device from the compute instance; and
releasing the compute instance to a pool of available compute instances.

9. A non-transitory computer-readable memory storing a plurality of instructions which when executed by one or more processors perform processing comprising:
responsive to a first input entered in a notebook requesting an emulator for a device,
receiving, by a computer system, a first request for the emulator for the device; and
identifying a compute instance that is loaded with the emulator for the device; and
responsive to a second input entered in the notebook identifying an application package to be loaded in the compute instance,
loading the application package in the compute instance; and
executing the emulator for the device based on the application package.

10. The non-transitory computer-readable memory of claim 9, wherein the application package includes a machine-learning model and a mobile application.

11. The non-transitory computer-readable memory of claim 9, wherein the first input identifies a manufacturer, and a device type characterizing the device.

12. The non-transitory computer-readable memory of claim 11, wherein the device type is further characterized by an operating system of the device, a form factor of the device, and a memory size of the device

13. The non-transitory computer-readable memory of claim 9, wherein the compute instance is a virtual machine.

14. The non-transitory computer-readable memory of claim 9, wherein the computer system includes a notebook session manager and an emulator instance controller, and wherein the receiving, the loading, and the executing are performed by the notebook session manager, and the identifying is performed by the emulator instance controller.

15. The non-transitory computer-readable memory of claim 14, further comprising:
provisioning, by the emulator instance controller, a plurality of compute instances, each of which is preloaded with an operating system and a particular emulator for a particular device.

16. The non-transitory computer-readable memory of claim 9, further comprising:
responsive to a third input entered in the notebook indicating a termination of the emulator for the device,
receiving, by the computer system, a third request indicating the third input;
uninstalling the emulator for the device from the compute instance; and
releasing the compute instance to a pool of available compute instances.

17. A computer system comprising:
a processor; and
a memory storing executable instructions, which when executed by the processor, causes the computer system to perform operations including:
responsive to a first input entered in a notebook requesting an emulator for a device,
receive a first request for the emulator for the device; and
identify a compute instance that is loaded with the emulator for the device; and
responsive to a second input entered in the notebook identifying an application package to be loaded in the compute instance,
load the application package in the compute instance; and
execute the emulator for the device based on the application package.

18. The computer system of claim 17, wherein the application package includes a machine-learning model and a mobile application.

19. The computer system of claim 17, wherein the first input identifies a manufacturer, and a device type characterizing the device.

20. The computer system of claim 19, wherein the device type is further characterized by an operating system of the device, a form factor of the device, and a memory size of the device, and wherein the compute instance is a virtual machine.
